(19) United States
(12) Patent Application Publication
(10) Pub. No.: US 2005/0068709 A1
(43) Pub. Date: Mar. 31, 2005

(54) System for overvoltage protection

(75) Inventors: Jacobus Theodorus Antonius Kouwenhoven, Almere (NL); Michiel Henricus Hartmann, Deventer (NL); Teunis Frans Krul, The Hague (NL)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Koninklijke KPN N.V.

(21) Appl. No.: 10/997,637

(22) Filed: Nov. 24, 2004

Related U.S. Application Data
(63) Continuation-in-part of application No. 10/311,158, filed on Dec. 13, 2002, now Pat. No. 6,853,529.

(30) Foreign Application Priority Data
Jul. 9, 2001 (EP) EP01/07884
Jul. 21, 2000 (NL) 1015766

(51) Int. Cl. H02H 9/06

(52) U.S. Cl. 361/118

(57) ABSTRACT

System for surge protection of an object comprising a supply unit, which is connected to the secondary output of an external transformer. The secondary windings of the external transformer are coupled in a star configuration, the star point of the transformer being connected to a downstream neutral conductor and an earth electrode provided near to the transformer. In the supply unit, at least one phase conductor is connected to the neutral conductor by means of a surge protective device of a first type, and the neutral conductor is connected to an earth electrode provided near to the supply unit by means of a surge protective device of a second type. The surge protective device of the first type comprises a voltage dependent resistor or varistor and the surge protective device of the second type comprises a lightning current arrester or spark gap element.

### CROSS-REFERENCE TO RELATED APPLICATIONS

The present patent application is a continuation-in-part application of pending U.S. patent application Ser. No. 10/311,158, filed on Dec. 13, 2002, which is a 371 application of PCT/EP01/07884, filed on Jul. 9, 2001, which claims priority under 35 U.S.C. § 119(a)-(d) to Netherlands Patent Application No. 1015766, filed on Jul. 21, 2000, the full disclosures of which are incorporated herein by reference.

### BACKGROUND

The invention relates to a system for lightning and surge protection of objects. In particular, the invention may be used as a system for lightning and surge protection for an object set up on a limited area, on the ground or on a building. Examples of such an object comprise an installation provided with an antenna, e.g. a GSM base station.

Surge protection devices for electrical power supplies are generally known. The protection device according to the application may be used to protect against surges with a high energy content, such as surges caused by lightning or electromagnetic pulse (EMP). More particularly, the application relates to protection against surge caused by lightning strikes in a power supply for electrical equipment set up in objects, such as transmitter/receiver stations for radio traffic.

For such a protection device, in addition to a number of specific components and measures, one or more (preferably at least two) earth electrodes are employed for the purpose of deflecting the charge which is inherent in the surge and distributing it over the greatest possible area. It goes without saying that these earth electrodes have the least possible resistance to the zero potential. It is, moreover, important that the ground area over which the charge of the lightning strike is to be distributed is at least of a minimum magnitude.

E.g., in the case of electrical power supplies for base stations for mobile telecommunications, such a minimum area is often not available because, for economic reasons, the area is preferably chosen to be no larger than necessary for the dimensions of the foot of the antenna mast. In the case that the object is positioned on top of a building, usually only a limited number of conductors with earth electrodes are used.

If the charge of a lightning or of EMP strikes the cabinet in which the power supply is housed or the metal frame to which the cabinet is attached, there is a danger of parasitic flash-over of the charge to the electrical conductors of the power supply. Since this charge is dissipated relatively poorly, the voltage in the power supply can rise to such an extent that flash-over can damage the components of the power supply, such as switches or cause failures of the power supply. Also, other equipment of the object, such as the equipment being supplied with power may be damaged.

That this voltage can be substantial can be understood from the fact that from a direct lightning strike a peak current of as much as 150 kA may arise, which must be deflected via an earth electrode having an impedance of 2.5 Ohm (this value being a standard value for earth electrodes, in practice, this value may be higher or lower).

Momentarily, this may lead to voltages of over 100 kV. For such a peak voltage, a power supply for low voltage applications is not equipped.

Such a parasitic flash-over is prevented according to the state of the art by connected surge protective devices, such as varistors or spark gaps, between the frame and each of the phased and between the frame and each of the neutral conductor of the power supply. The frame is connected directly to an earth connection, such as one or more earth electrodes. This way, parasitic flash-over from the part on which the strike occurs to one of the conductors is prevented.

In this known solution, however, it cannot be prevented that in the power supply substantial damage occurs when a direct lightning strike occurs on the frame, which will be further explained in the detailed description. Here, it suffices to mention that this damage may comprise the burning of one or more components of the power supply caused by the very large currents. Moreover, mechanical damage may arise in the power supply as the large currents flowing through the conductors to be pulled from the connection points, through the electromagnetic fields caused by the large currents, as a result of which an interruption in the current flow occurs.

It need not be mentioned that, also because of the earlier mentioned periphery arrangement of the power supply and the less proper accessibility thereof, repair of the damage will take a lot of time. As a result, the installation powered by the power supply will be out of service for a longer period of time, which leads to a higher risk of operational damage.

European patent application EP-A-0 128 344 describes an arrangement for surge arresters in a high voltage transformer. In this arrangement, surge arresters are connected between each phase conductor and the neutral conductor, and also between the neutral conductor and an earth electrode. The surge arresters are all of the same type. Additionally, a capacitor is connected between the neutral conductor and a second earth electrode. This results in a protection of the transformer against too high voltage peaks, in which the capacitor controls the dynamic behavior of the surge arresters. The surge arresters are usually chosen to be spark gap elements, as these can be used in high voltage applications. The arrangement described is meant specifically for protection of the high voltage transformer.

A disadvantage of the use of spark gap elements or spark gaps connected between the phase conductors and the neutral conductor is that a rest voltage results which is poorly defined and usually too large. Furthermore, spark gaps will keep an undefined rest voltage, dependent on the rise time of the lightning pulse, which may be 2.5 or 4 kV, which is too high for low voltage equipment. Also, the spark gap elements cause a short circuit and thus a net following current, which almost certainly results in breakdown of the fuses (of the electricity provider). Breakdown of the fuses results in operational down time of the equipment supplied by the transformer.

In a conference paper “Bliksem Seminar 1999,” 1999, page 49, FIG. 17, from which the claims are delimited, a lightning protective device is shown that comprises a first protective device that is the same as the lightning protection device as shown in EP-A-0 128 344. However, this FIG. 17 also shows an additional protective device that comprises varistors between the three phase conductors and the neutral conductor, and a spark gap between the neutral conductor and an earth electrode. This additional protective device is arranged downstream from the first protective device, seen in a direction from the mains. The first protective device is disclosed to comprise components of a lightning current capability of a class B, corresponding to a lightning protection class of >50 kA (10/350 μs), >75 kA (10/350 μs), or 100 kA (10/350 μs). The additional protective device is disclosed to be an overvoltage protection device with class C components. Class C components have a surge current capacity of >20 kA (8/20 μs).

The present invention seeks to provide a system for surge protection for use in low voltage applications, which does not have the disadvantages of the known systems described above. The present invention also seeks to provide a solution to the problem that the power supply defined in the preamble above, has such a limited deflection path to earth in order to deflect the charge of the strike, that the peak voltage occurring is relatively high and decreases relatively slowly.

### SUMMARY

According to the present invention, a system for surge protection is provided. The surge protective device of the first type is primarily meant to provide a well defined safety level (maximum voltage over its connection leads) and the surge protection device of the second type is primarily meant to arrest or deflect high currents.

By using different types of surge arresters between the phase conductors and the neutral conductor and between the neutral conductor and the earth electrode, the system provides a very efficient surge protection, e.g. caused by lightning strike on an object. The solution of the present invention has as one insight whereon the invention is based that the frontal edge of the lightning current flow through the connected conductors (i.e. the supply conductors and other conductors). It is believed that this phenomenon occurs because of the limited ground surface to which the earth electrode is connected. The neutral conductor between the power supply unit and transformer to which the power supply unit is connected, is not connected to a self-induction while the phase conductors are connected to a self-induction. The self-induction may be a transformer coil or winding, or a coil of a kilo-watt hour meter. This causes that the current through the neutral conductor will be larger than the current through the phase conductors.

The surge protective device of the first type is a voltage dependent resistor, or varistor. The resistance value of such an element abruptly decreases when the voltage over the element passes a preset voltage value. The surge protective device of the second type is spark gap element, or spark gap. These elements cause a discharge to occur when the voltage across its terminals increase above a present value, and are usually applied when high voltages are to be expected.

The surge protective devices of the first type ascertain that smaller currents flow through the phase conductors while also ascertaining that too high a voltage on the phase conductors is limited to a well defined value. Furthermore, the surge protective device of the second type ascertains that the large lightning current flows via the element into the neutral conductor which is not provided with a fuse.

In an embodiment of the present invention, the surge protective device of the first type and surge protective device of the second type are included in front of a switch provided in the supply unit, seen in the direction of power flow from the external transformer. This arrangement assures that the currents caused by a lightning strike or EMP do not flow through the switch of the system, resulting in a better protection of one of the elements of the power supply. In former actual cases of damage caused by lightning strike, the switch was completely burnt.

In a further embodiment of the present system the switch may be switched off by means of an earth leakage circuit breaker. The earth leakage circuit breaker is also protected by the present system. Earth leakage circuit breakers are applied in general for high impedance earth circuits. In a normal arrangement (surge arresters between phase and earth) a defect in one of the surge arrestors can lead to too high voltage of the high impedance earth, and thus also for the connected equipment. The normal protection system can thus only be used after the earth leakage circuit breaker, in order to disconnect such as unwanted situation, and as a result, the earth leakage circuit breaker may still be damaged when a lightning strikes. The present invention, however, may be positioned in front of the earth leakage circuit breaker, as by using a spark gap, no galvanic connection is present between the neutral conductor and earth. As a result, the earth (and all connected equipment) can not be put on too high a voltage when one of the surge arresters fails.

In a further embodiment, the earth leakage circuit breaker is of a self-resetting type. Such an earth leakage circuit breaker will reset after a predetermined period of time, thus reconnecting the power supply automatically. When there still is an earth failure, the earth leakage circuit breaker will switch off again.

In an even further embodiment, the surge protective device of the second type is of the non blowing-off type. The surge protective device of the first type is a voltage dependent resistor or varistor and the surge protective device of the second type is a lightning current arrester or spark gap element. This arrangement assures that no hot gasses or high pressure occur, which are typical for state of the art spark gap elements which are blowing off.

The elements of the power supply unit are positioned inside a closed cabinet. This allows a small and reliable cabinet comprising the elements of the power supply (i.e., power supply connects and the protection circuitry), which is moreover cost-effective and easy to assemble. By using surge protective devices of the non blowing-off type, the cabinet will not be exposed to high internal pressures or hot gasses. This also has the added advantage that the connection between neutral conductor and surge protective device may be a short connection which results in less mechanical forces on the connections caused by strong electromagnetic fields.

The surge protective device of the second type has a rating of at least about 40 kA, more preferably at least about 50 kA and even more preferably at least about 100 kA. This will allow an effective surge protection system offering protection to currents which have been encountered in practice after lightning strikes on objects with a small foot print.

The surge protective device of the first type has a rating of at least about 4 kA, more preferably at least about 8 kA. This will suffice for the currents flowing through these elements occurring after a lightning strike.

In a further embodiment, the neutral conductors of the system and the interconnections between the neutral conductors have a diameter of at least about 8 mm², more preferably at least about 16 mm². Also the conductors connected to the earth electrodes and all interconnecting items have a diameter of at least about 8 mm², more preferably at least about 16 mm². This should include all connections through which current flows, including interconnections of clamps to which the neutral conductors or earth conductors are connected. The highest currents will flow through the neutral conductors and to the earth electrodes, and as a result the complete path through which these currents flow should have a predetermined minimal diameter. Preferably, at least part of the conductors connected to the earth electrode is formed by a metal plate. This allows an effective flow of the current over the neutral and earth conductors leading to lower electromechanical forces.

### SHORT DESCRIPTION OF THE DRAWING

The invention will now be explained in further detail referring to the drawing, in which:

FIG. 1 shows a schematic diagram of a system for protection of low voltage equipment according to the prior art;

FIG. 2 shows a schematic diagram of a first embodiment of a system according to the invention;

FIG. 3 shows a schematic diagram of a second embodiment of a system according to the invention.

### DETAILED DESCRIPTION OF AN EMBODIMENT

In FIG. 1, which shows the state of the art, I indicates the part which is positioned in the space of the electricity supplier. Three windings of a transformer are referenced by number 1, the secondary winding of the transformer being in a star configuration of which the star point is earthed. The impedance existing between the star point and the point of the zero potential is indicated by Ra, which usually has a very low value, e.g., a 0.5 Ohm and a self inductance of e.g., 5 μH. The secondary windings of the transformer usually have a resistance value of about 0.01 Ω and a self inductance of 50 μH. In this space, also the fuses 2 are positioned.

The equipment of the user, in the part indicated with II, comprises a three phase switch 3. Each of the conductors (phase and neutral) is connected behind the switch 3 to a connection 5 via a surge arrester 4, such as a voltage dependent resistor or varistor. The connection 5 is connected to the frame of the switch closet (or object). This connection 5 is being earthed by means of a earth conductor, the impedance of which is Rb. The conductors leading away from the switch 3, which supply the further equipment with energy, are indicated with reference numeral 6 for the phase conductors and reference numeral 7 for the neutral conductor. The further equipment is provided with possible own protection and has a relatively high input impedance.

When a lightning strike hits the frame of the object, the charge must be deflected via the earth conductor 5 to earth. In an ideal case, the impedance Rb, via which the lightning energy is deflected, has a zero value. Standardization norms for lightning protection require a value of maximum 2.5 Ohm.

A limiting factor for the deflection of the energy caused by the lightning strike is the small ground surface on which the object (or equipment) is usually positioned. The small dimensions of the ground surface prevent a quick deflection of a large amount of charge within a short time period. This substantially enhances the chance of heating of the equipment in the object II and also the risk of voltage flash-over.

In a lightning strike in which a momentary value of the current may be as high as 150 kA, a voltage on the earth conductor 5 may be as high as 75 kV. This voltage may easily flash over to the flash over to the switch 3, which in normal operation is closed. In almost all situations, such a flash-over will cause severe damage of the switch 3 and often to melting of the fuses 2.

In order to keep the peak voltage as low as possible and to limit the time period as much as possible, surge arresters 4, such as voltage dependent resistors are provided. The largest current will usually flow through the neutral conductor 7, as this has the lowest impedance value.

At a lightning strike on the frame, the resistors 4 will decrease the danger of flash surge to the fuses 2 and switch 3, but the large currents that will flow from part II to part I (of the electricity supplier) will still have values which may be substantially higher than 40 kA, as a result of which still burning phenomena will occur on the fuses 2 and switch 3.

As a result of the arrangement of the object II, this may lead to a prolonged period of time in which the object II is not operational, which disturbs the service supplied by the equipment in an economically non-attractive fashion.

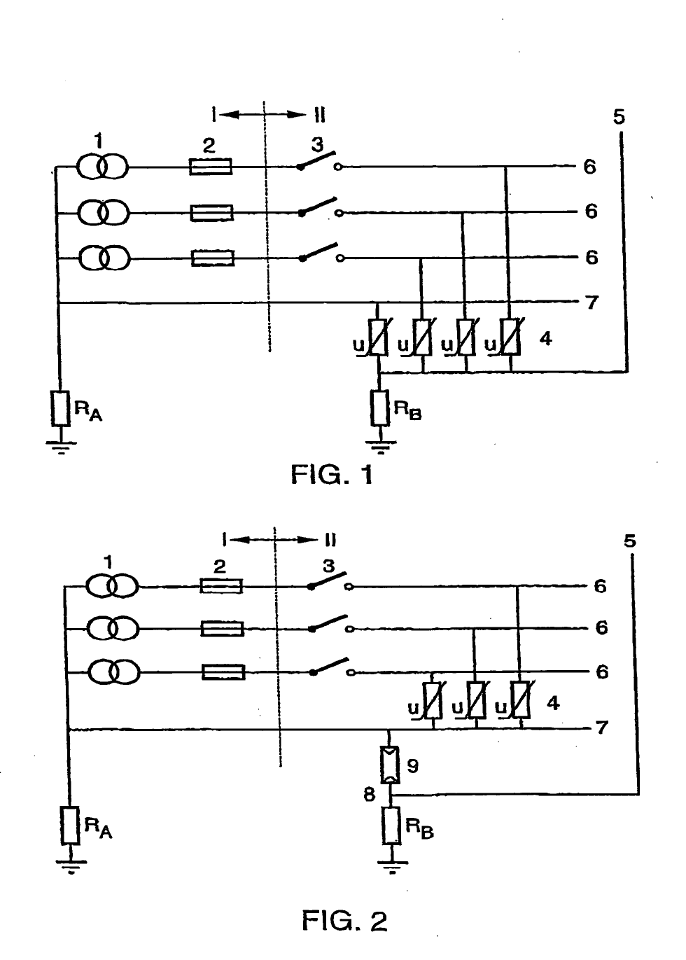

The circuit according to FIG. 2 provides a solution to this problem in accordance with the present invention. The voltage dependent resistors 4, which are on one side connected with the phase conductors 6, are not connected on the other side to the earth conductor 5, but with the neutral conductor 7. The neutral conductor 7 now connects the lightning current arrester 9 with the earth conductor 5.

Such a lightning current arrester, which at flash-over causes a short circuit situation of limited time duration, is known in the art (see e.g. German patent applications DE-A-19 74 2302 and DE-A-19 75 5082 and European patent application EP-A-0 128 244 mentioned in the introduction).

When a lightning strikes the frame of the object II, the peak voltage on the phase conductors 6 will now be largely suppressed by the voltage resistors 4. The lightning current arrester 9 will cause an almost complete short circuit between the neutral conductor 7 and the earth conductor 8, resulting in that the current caused by the strike is only partially deflected from the object II to the transformer in part I via the phase conductors 6.

The peak current to be deflected, will not be deflected via the parallel circuit of the earth resistances Ra and Rb. Of course, the resistance of the phase conductors 6 and the neutral conductor 7 between the object II and the transformer in part I still plays a role, but in practical situations this connection will not result in problems because of the low impedance.

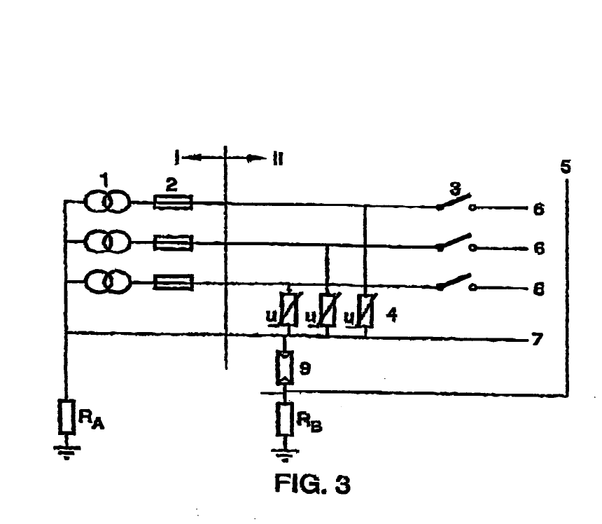

FIG. 3 shows a further embodiment of the system according to the present invention, in which the switch 3, viewed in the direction of power flow to the equipment in part II, is positioned behind the components for current and voltage suppression. This further reduces the risk of overload of the switch 3 by large currents. The only components in the system upward of the protection system are the fuses 2 of the electricity provider. Although tests have shown that the lightning inducted currents through the phase conductors 6 are relatively small, it may still occur that the fuses 2 break down. To assure that down time due to blown fuses 2 is minimized, it is preferred that the fuses 2 are of the automatic type, as these can better withstand the lightning induced currents than fuses 2 of the melting type. Moreover, the fuses 2 of the automatic type can be reset manually, or form a remote location.

The surge protective device of the second type has a rating of at least 40 kA, more preferably at least 50 kA and even more preferably at least 100 kA. This will allow an effective surge protection system offering protection to currents which have been encountered in practice when lightning strikes on objects with a small foot print. The surge protective devices 4 of the first type have a rating of at least 4 kA, more preferably at least 8 kA. This will suffice for the currents flowing through these elements occurring after a lightning strike.

All elements of the embodiments described above, are integrated into a single cabinet. Using a surge protection device of a non blowing-off type will allow to also integrate this element in the cabinet, as no hot gasses or high pressures can occur. To be able to withstand the high currents flowing through it, the neutral conductor 7 and/or earth conductor 5 of the system and the interconnections between them (such as clamps, etc.) are all made of a material having a diameter of at least 8 mm², and more preferably at least 16 mm². This should include all connections through which current flows, including interconnections of clamps to which the neutral conductor 7 and/or earth conductor 5, and as a result the complete path through which these currents flow should have a predetermined minimal diameter. Preferably, at least part of the earth conductor 5 is formed by a metal plate. This allows an effective flow of the current over the earth conductor 5 leading to lower electromechanical forces. Also, the connections to the earth electrodes (towards Ra and Rb in FIGS. 2 and 3) should have a minimum diameter. In the closed cabinet, special attention should be given to the mounting of the lightning current arrester 9, as the highest currents will flow through this element with a lightning strike. These currents may cause large electromagnetic forces, which may damage the mounting of the element 9.

It is evident that the effect according to the present invention will also occur when the incoming conductors are connected to a kilowatt-hour meter present in the space indicated by roman numeral I.

It will also be clear that the solution according to the present invention is also usable for a single phase power supply.

1. A system for surge protection of an object, the system comprising:
a single cabinet; and
a supply unit positioned within the single cabinet, the supply unit including at least one phase conductor that is connected to a neutral conductor by means of a surge protective device of a first type, the surge protective device of a first type including a voltage dependent resistor or varistor with a predetermined first rating that is at least about 4 kA,
wherein the neutral conductor is connected to an earth electrode of the object by means of a surge protective device of a second type, the surge protective device of a second type including a lighting current arrestor or spark gap element with a predetermined second rating that is at least about 40 kA, and
wherein the at least one phase conductor is arranged to be connected to a transformer phase conductor of an external transformer, and wherein the surge protective device of the first type and the surge protective device of the second type are designed to carry all currents caused by lightning or electromagnetic pulse, in case no other surge protective device is applied between said system and said external transformer.

2. The system according to claim 1, in which the surge protective device of the first type and the surge protective device of the second type are included in front of a switch provided in the supply unit, seen in the direction of power flow from the external transformer of which a secondary output is connected to the supply unit.

3. The system according to claim 1, in which at least one phase conductor a decoupling impedance is provided and in which, seen in the direction of power flow from the external transformer, at least one phase conductor is connected to the neutral conductor between an input of the supply unit and the decoupling impedance by means of a further surge protective device of the second type, and in which the part of the phase conductor behind the decoupling impedance is connected to the neutral conductor by means of a further surge protective device of the second type.

4. The system according to claim 1, in which the switch may be switched off by means of an earth leakage circuit breaker.

5. The system according to claim 4, in which the earth leakage circuit breaker is of a self-resetting type.

6. The system according to claim 1, in which the surge protective device of the second type is non blowing-off.

7. The system according to claim 1, in which the surge protective device of the second type has a rating of at least about 50 kA.

8. The system according to claim 1, in which the surge protective device of the second type has a rating of at least about 100 kA.

9. The system according to claim 1, in which the surge protective device of the first type has a rating of at least about 8 kA.

10. The system according to claim 1, in which the neutral conductor of the system and the interconnections between the neutral conductor have a diameter of at least about 8 mm².

11. The system according to claim 1, in which the neutral conductor of the system and the interconnections between the neutral conductor have a diameter of at least about 16 mm².

12. The system according to claim 1, in which the conductors connected to the earth electrodes of the system and the interconnections between the conductors have a diameter of at least about 8 mm².

13. The system according to claim 1, in which the conductors connected to the earth electrodes of the system and the interconnections between the conductors have a diameter of at least about 16 mm².

14. The system according to claim 1, in which at least part of conductors connected to the earth electrode is formed by a metal plate.

15. The system according to claim 1, in which the surge protective device of the first type and the surge protective device of the second type are included in front of a switch provided in the supply unit, seen in the direction of power flow from the external transformer.

16. The system according to claim 15, in which the switch may be switched off by means of an earth leakage circuit breaker.

17. The system according to claim 16, in which the earth leakage circuit breaker is of a self-resetting type.

18. A power supply system comprising:
a transformer with at least one transformer phase conductor; and
at least one system for surge protection of an object, the system including a supply unit having at least one phase conductor that is connected to a neutral conductor by means of surge protective device of a first type, and
wherein the neutral conductor is connected to an earth electrode of the object by means of a surge protective device of a second type, the surge protective device of the first type comprising a voltage dependent resistor or varistor with a predetermined first rating and the surge protective device of a second type comprises a lighting current arrestor or spark gap element which has a predetermined second rating, characterized in that said first rating is at least 4 kA and the second rating is at least 40 kA,
the elements of the supply unit being positioned inside a single cabinet, the at least one phase conductor being arranged to be connected to the at least one transformer phase conductor of the transformer and the surge protective device of the first type and the second type being designed to carry all currents caused by lightning or electromagnetic pulse, in case no other surge protective device is applied between said system and said transformer.
